(19) United States
(12) Patent Application Publication
(10) Pub. No.: US 2006/0253369 A1
(43) Pub. Date: Nov. 9, 2006

(54) Method of creating and trading derivative investment products based on an average price of an underlying asset during a calculation period

(75) Inventor: Dennis M. O'Callahan, Evanston, IL (US)

Correspondence Address: BRINKS HOFER GILSON & LIONE, P.O. BOX 10395, CHICAGO, IL, 60610, US

(73) Assignee: Chicago Board Options Exchange

(21) Appl. No.: 11/122,512

(22) Filed: May 4, 2005

(51) Int. Cl. G06Q 40/00

(52) U.S. Cl. 705/37

(57) ABSTRACT

A method of creating and trading derivative contracts based on an average trading price of an underlying asset over a calculation period is disclosed. Typically, an underlying asset is chosen to be a base of an Asian derivative and a processor calculates a cumulative realized average price reflecting an average trading price of an underlying asset during a calculation period. A trading facility display device coupled to a trading platform then displays the Asian derivative and the trading facility transmits Asian derivative quotes from liquidity providers over at least one dissemination network.

### FIELD OF THE INVENTION

The present invention relates to derivative investment markets. More specifically, this invention relates to aspects of actively disseminating and trading derivatives.

### BACKGROUND

A derivative is a financial security whose value is derived in part from a value or characteristic of another security, known as an underlying asset. Two exemplary, well known derivatives are options and futures.

An option is a contract giving a holder of the option a right, but not an obligation, to buy or sell an underlying asset at a specific price on or before a certain date. Generally, a party who purchases an option is referred to as the holder of the option and a party who sells an option is referred to as the writer of the option.

There are generally two types of options: call options and put options. A holder of a call option receives a right to purchase an underlying asset at a specific price, known as the “strike price,” such that if the holder exercises the call option, the writer is obligated to deliver the underlying asset to the holder at the strike price. Alternatively, the holder of a put option receives a right to sell an underlying asset at a specific price, referred to as the strike price, such that if the holder exercises the put option, the writer is obligated to purchase the underlying asset at the agreed upon strike price. Thus, the settlement process for an option involves the transfer of funds from the purchaser of the underlying asset to the seller, and the transfer of the underlying asset from the seller of the underlying asset to the purchaser. This type of settlement may be referred to as “in kind” settlement. However, an underlying asset of an option does not need to be tangible, transferable property.

Options may also be based on more abstract market indicators, such as stock indices, interest rates, futures contracts and other derivatives. In these cases, in kind settlement may not be desired, or in kind settlement may not be possible because delivering the underlying asset is not possible. Therefore, cash settlement is employed. Using cash settlement, a holder of an index call option receives the right to “purchase” not the index itself, but rather a cash amount equal to the value of the index multiplied by a multiplier such as $100. Thus, if a holder of an index call option elects to exercise the option, the writer of the option is obligated to pay the holder the difference between the current value of the index and the strike price multiplied by the multiplier. However, the holder of the index will only realize a profit if the current value of the index is greater than the strike price. If the current value of the index is less than or equal to the strike price, the option is worthless due to the fact the holder would realize a loss.

Similar to options contracts, futures contracts may also be based on abstract market indicators. A future is a contract giving a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not ever change hands. Instead, futures contracts may be settled in cash such that to settle a future, the difference between a market price and a contract price is paid by one investor to the other. Again, like options, cash settlement allows futures contracts to be created based on more abstract “assets” such as market indices. Rather than requiring the delivery of a market index (a concept that has no real meaning), or delivery of the individual components that make up the index, at a set price on a given date, index futures can be settled in cash. In this case, the difference between the contract price and the price of the underlying asset (i.e., current value of market index) is exchanged between the investors to settle the contract.

Derivatives such as options and futures may be traded over-the-counter, and/or on other trading facilities such as organized exchanges. In over-the-counter transactions the individual parties to a transaction are free to customize each transaction as they see fit. With trading facility traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading facility, and will typically be related to the value of the underlying asset.

While standard derivative contracts may be based on many different types of market indexes or statistical properties of underlying assets, current standard derivative contracts do not provide investors with sufficient tools to create and trade derivatives based on an average price of an underlying asset over a specified period of time.

### BRIEF SUMMARY

Accordingly, the present invention relates to a method of creating and trading derivative contracts based on an average price of the underlying asset over a calculation period, also known as an Asian derivative or an average price derivative. An Asian derivative is a financial instrument such as a futures or option contract that trades on trading facilities, such as exchanges, whose value is based on an average price of an underlying asset during a calculation period.

In a first aspect, the invention relates to a method of creating derivatives based on an average trading price of an underlying asset during a calculation period. Trading price information relating to an underlying asset is received. A processor calculates the average trading price of the underlying asset during the calculation period as a function of the received trading price information and an Asian derivative based on the average trading price is displayed on a trading facility display device coupled to a trading platform. The trading facility then transmits Asian derivative quotes of a liquidity provider to at least one market participant.

In a second aspect, the invention relates to a method of creating derivatives based on an average price of an underlying asset. First, an underlying asset is chosen to be a base of an Asian derivative. Trading price information relating to the underlying asset is received and an average trading price of the underlying asset over a calculated period is calculated. A trading facility display device displays at least one Asian derivative based on the calculated average trading price and bids and offers to buy and sell positions in the at least one Asian derivative are received. Finally, trades for the at least one Asian derivative are executed by matching bids and offers to buy and sell positions in the at least one Asian derivative.

In a third aspect, the invention relates to a system for creating and trading derivatives based on an average price of an underlying asset during a calculation period. Typically, the system comprises an average trading price module coupled with a communications network, a dissemination module coupled with the average trading price module and the communications network, and a trading module coupled with the dissemination module and the communications network.

Generally, the average trading price module calculates a cumulative realized average price of the underlying asset during the calculation period. The average trading price module passes the cumulative realized average price to the dissemination module, which transmits the cumulative realized average price to at least one market participant. The trading module receives buy or sell orders for an Asian derivative based on the underlying asset, executes the buy or sell orders, and passes the result of the buy or sell orders to the dissemination module to transmit the result of the buy or sell order to at least one market participant.

### BRIEF DESCRIPTION OF THE DRAWINGS

FIG. 1 is a flow chart of a method of creating and trading an Asian derivative;

FIG. 2 is a diagram showing a listing of Asian futures contracts and Asian option contracts on a trading facility;

FIG. 3 is a block diagram of a system for creating and trading Asian derivatives; and

FIG. 4 is a table showing values for an Asian derivative over a calculation period.

### DETAILED DESCRIPTION OF THE DRAWINGS

Asian derivatives are financial instruments such as futures and option contracts that trade on trading facilities, such as exchanges, whose value is based on an average price of an underlying asset during a calculation period. The average of the underlying asset may be calculated using arithmetic averages, geometric averages, or any other type of average known in the art.

Those skilled in the art will recognize that Asian derivatives having features similar to those described herein and values which reflect an average price of an underlying asset during a calculation period, but which are given labels other than Asian derivatives, Asian futures, or Asian options will nonetheless fall within the scope of the present invention.

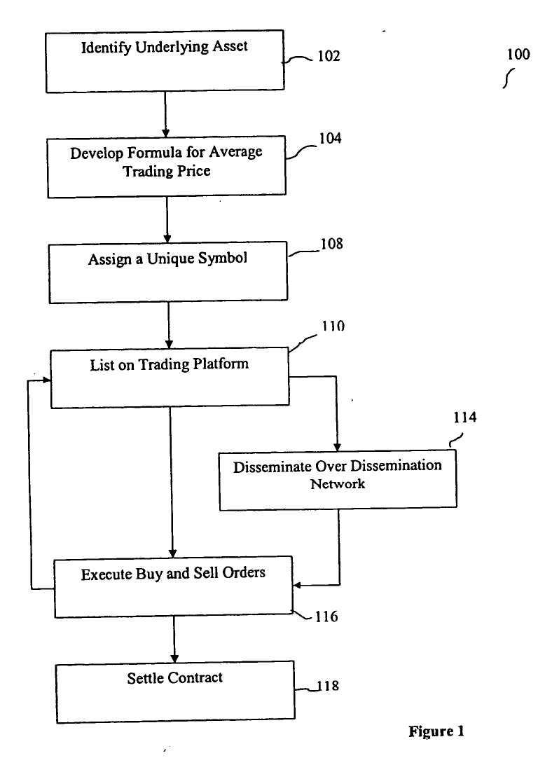

FIG. 1 is a flow chart of one embodiment of a method for creating and trading an Asian derivative 100. An Asian derivative is a financial instrument in which an average of an underlying asset is calculated over a predefined time period, known as the calculation period. The average of the underlying asset may be calculated continuously or periodically at set time periods throughout the calculation period. Typically, the average value of the underlying asset may be an arithmetic average or a geometric average of the trading price of the underlying asset, but any type of average of the trading price of the underlying asset during the calculation period could be used. The trading price may be the opening price of the underlying asset, the closing price of the underlying asset, or any other designated price chosen by a trading facility.

An investor is generally able to purchase an Asian derivative before a calculation period begins, or an investor may trade into or out of an Asian derivative during the calculation period. To facilitate the purchase and trading of Asian derivatives, trading facilities such as exchanges like the Chicago Board Options Exchange (“CBOE”) Network will calculate and disseminate a cumulative realized average price and an implied average price for an underlying asset that is the base of an Asian derivative. The cumulative realized average price and implied average price provide a tool for investors to determine when to trade into and out of an Asian derivative.

The method for creating and trading an Asian derivative begins at step 102 by identifying an underlying asset or a set of underlying assets for the Asian derivative. Typically, an underlying asset or set of assets is selected based on trading volume of a prospective underlying asset, the general level of interest of market participants in a prospective underlying asset, or for any other reason desired by a trading facility. The underlying assets for the Asian derivative may be equity indexes or securities; fixed income indexes or securities; foreign currency exchange rates; interest rates; commodity indexes; commodity or structured products traded on a trading facility or in the over-the-counter (“OTC”) market; or any other type of underlying asset which trades over the calculation period.

Once the underlying asset or assets have been selected at 102, a formula is developed at 104 for generating an average trading price of the underlying asset or assets during the defined calculation period. In one embodiment, the average is calculated as an arithmetic average according to the formula:

$$Arithmetic Average = \frac{{\sum }_{i = 1}^{N} {TP}_{i}}{N} ,$$

wherein TPᵢ is a trading price of the underlying asset during the calculation period and N is the number of trading prices of the underlying asset during the calculation period. In another embodiment, the average is calculated as a geometric average according to the formula:

$$Geometric Average = \sqrt[N]{{TP}_{1} * {TP}_{2} . * … * {TP}_{N}} ,$$

wherein TP₁ through TP_{N} is each of the trading prices of the underlying asset during the calculation period and N is the number of trading prices of the underlying asset during the calculation period.

Once the underlying asset or assets is chosen at 102 and the formula for generating the average of the trading prices of the underlying asset during the calculation period is determined at 104, the Asian derivative based on the chosen underlying asset or assets is assigned a unique symbol at 108 and listed on a trading platform at 110. Generally, the Asian derivative may be assigned any unique symbol that serves as a standard identifier for the type of standardized Asian derivative.

Generally, an Asian derivative may be listed on an electronic platform, an open outcry platform, a hybrid environment that combines the electronic platform and open outcry platform, or any other type of platform known in the art. One example of a hybrid exchange environment is disclosed in U.S. patent application Ser. No. 10/423,201, filed Apr. 24, 2003, the entirety of which is herein incorporated by reference. Additionally, a trading facility such as an exchange may transmit Asian derivative quotes of liquidity providers over dissemination networks 114 to other market participants. Liquidity providers may include Designated Primary Market Makers (“DPM”), market makers, locals, specialists, trading privilege holders, registered traders, members, or any other entity that may provide a trading facility with a quote for an Asian derivative. Dissemination Networks may include networks such as the Options Price Reporting Authority (“OPRA”), the CBOE Futures Network (“CFN”), an internet website, or email alerts via email communication networks. Market participants may include liquidity providers, brokerage firms, normal investors, or any other entity that subscribes to a dissemination network.

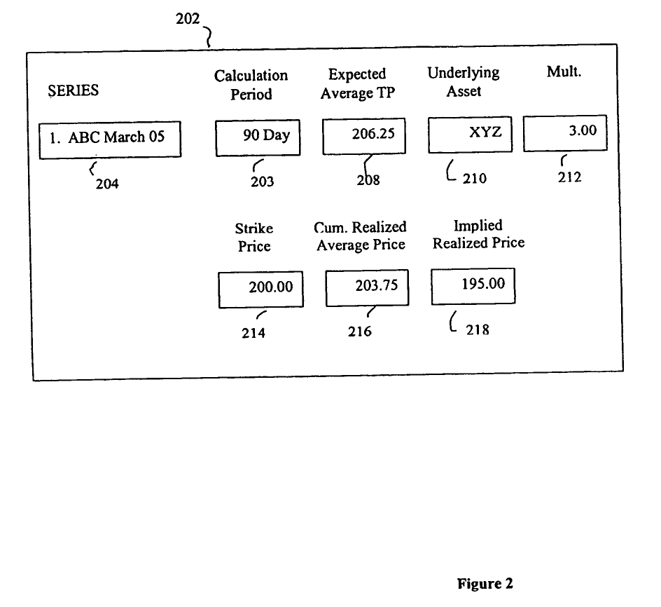

As seen in FIG. 2, Asian derivatives are listed on a trading platform by displaying the Asian derivative on a trading facility display device 202 coupled with the trading platform. Typically, an Asian derivative 204 will be listed in terms of the calculation period 206 and an expected average trading price 208. The trading facility device 202 may also display the name or symbol of the underlying asset itself 210, any multipliers for the Asian derivative 212, or the strike price of the Asian derivative 214, if structured as an option.

Over the course of the calculation period, the display device may also display and disseminate values such as a cumulative realized average price 216 and an implied average price 218 on a daily basis, or in real-time, to facilitate trading within the Asian derivatives. A cumulative realized average price 216 is the average trading price of the underlying asset up to the current day or time of the calculation period. The implied realized price 218 is a weighted average of both the cumulative realized average price 216 and a most recent closing price of the Asian derivative during the calculation period. Specifically, if the Asian derivative is a future, implied average price may be calculated according to the formula:

$$Implied Average Price = \frac{TP - RAP * \frac{{Day}_{Current}}{{Day}_{Total}}}{{Day}_{Left} / {Day}_{Total}} ,$$

where TP is the last trading price of the Asian futures contract; RAP is the cumulative realized average price; Day_{Current} is the total number of trading days that have passed in the calculation period; Day_{Total} is the total number of trading days in the calculation period; and Day_{Left} is the number of trading days left in the calculation period.

However, if the Asian derivative is an option, implied average price may be calculated according to the formula:

$$Implied Average Price = \frac{( {C}_{A} - {P}_{A} + {S}_{A} ) - RAP * \frac{{Day}_{Current}}{{Day}_{Total}}}{{Day}_{Left} / {Day}_{Total}} ,$$

where C_{A} is a value paid for a long at-the-money call; P_{A} is the value received for the at-the-money short put; S_{A} is the at-the-money option strike price; RAP is the cumulative realized average price; Day_{Current} is the total number of trading days that have passed in the calculation period; Day_{Total} is the total number of trading days in the calculation period; and Day_{Left} is the number of trading days left in the calculation period.

In FIG. 2, an Asian derivative 204 is listed having a calculation period 206 of 90 days and an expected average trading price of 206.25 (208). In other embodiments, the calculation period 206 may be a one-month calculation period or any other period of time defined by a trading facility. Further, the expected average trading price 208 is determined by market participants based on the information available at the time. In addition to listing Asian derivatives 204 in terms of a calculation period 206 and an expected price 208, an Asian derivative 204 may also be listed in terms of a decimal, fractions, or any other numerical representation of an average trading price for an underlying asset at the end of a calculation period.

Referring to FIG. 1, the cumulative realized average price provides investors a tool for determining when to trade into and out of Asian derivatives at 116. Trades for Asian derivatives are normal executed by matching bids and offers to buy and sell positions in Asian derivatives.

At expiration of the calculation period for an Asian derivative, the trading facility will settle 118 the Asian derivative based on the average trading price of the underlying asset during the calculation period. At settlement 118, the cumulative realized average price will reflect the average trading price of the underlying asset over the entire calculation period as calculated by the trading facility or an independent liquidity provider. In one embodiment, settlement of the Asian derivative may be based on a cash difference between the average trading price of the underlying asset at the end of the calculation period and the closing price of the underlying asset at the end of the calculation period.

In another embodiment, the Asian derivative may be structured as an Asian futures contract to require delivery of the underlying asset. In an Asian futures contract, the purchaser of the Asian futures contract receives a right to receive delivery of the underlying asset at the end of the calculation period and the seller of the Asian futures contract agrees to deliver the underlying asset at the end of the calculation period for the average price of the underlying asset during the calculation period. Therefore, at the end of the calculation period, if the average price of the underlying asset during the calculation period is below the current price of the underlying asset, the buyer of the Asian futures contract will make a profit due to the fact the buyer purchases the underlying asset at a price less than currently available in the open market. However, at the end of the calculation period, if the average price of the underlying asset during the calculation period is the same or more than the current price of the underlying asset in the open market, the buyer of the Asian future will realize a loss due to the fact the buyer must purchase the underlying asset at a price higher than its value on the open market.

In yet another embodiment, the Asian derivative may be structured as an Asian option contract. In an Asian call option contract, the holder of the option receives a right to purchase the underlying asset at a strike price of a specified average trading price of the underlying asset during the calculation period and the writer of the option agrees to sell the underlying asset to the holder at the strike price. Alternatively, in an Asian put option contract, the holder of the option receives a right to sell the underlying asset at a strike price of a specified average trading price of the underlying asset during the calculation period to the writer of the Asian put option contract. Asian option contacts may be structured so that the holder of the option may exercise the option at any time during the calculation period or be structured so that the holder of the option may exercise the option only at the end of the calculation period.

Asian derivatives may additionally be structured as Flexible Exchange (“FLEX”) derivatives so that various terms of the Asian derivative are variable. For example, the parties to an Asian FLEX derivative may set terms in the contract such as strike price, expiration date, or exercise style in a manner different from the standard terms of regular Asian derivatives.

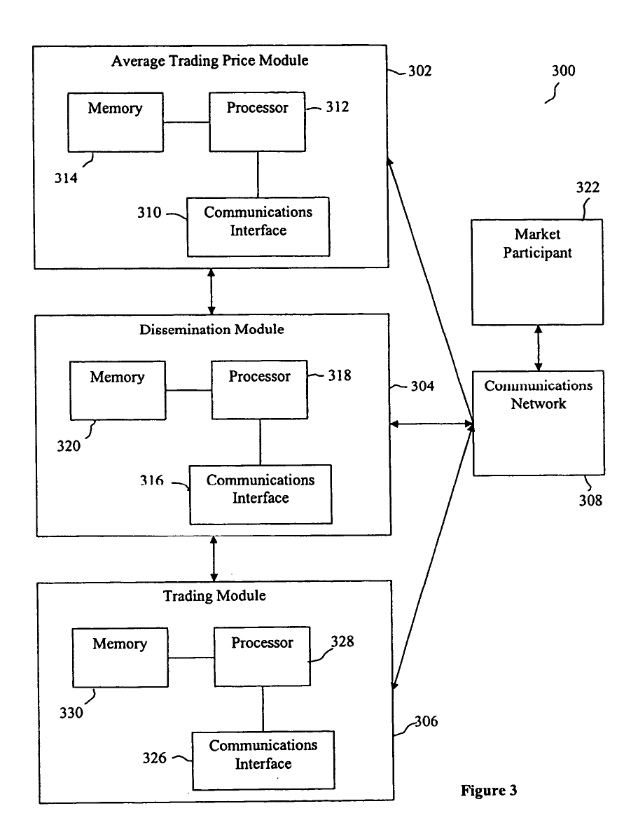

FIG. 3 is a block diagram of a system 300 for creating and trading Asian derivatives. Generally, the system comprises an averaging module 302, a dissemination module 304 coupled with the averaging module 302, and a trading module 306 coupled with the dissemination module 304. Typically, each module 302, 304, 306 is also coupled to a communication network 308 coupled to market participants 322. Each module 302, 304, 306 may comprise software and hardware components implemented on one or more computers. Additionally, each module may be located at the same or different trading facilities.

The averaging module 302 comprises a communications interface 310, a processor 312 coupled with the communications interface 310, and a memory 314 coupled with the processor 312. The processor 312 executes logic stored in the memory 314 to receive information relating to the price at which an underlying asset is being traded through the communications interface 310. Typically, the averaging module 302 receives information relating to the price at which an underlying asset is being traded from an index provider such as data vendors.

The processor 312 additionally executes logic stored in the memory 314 to calculate a cumulative realized average price value, as described above, using an arithmetic average, a geometric average, or any other type of average. Further, the processor 312 executes logic stored in the memory 314 to pass the calculated average trading price to the dissemination module through the communications interface 310.

The dissemination module 304 comprises a communications interface 316, a processor 318 coupled with the communications interface 316, and a memory 320 coupled with the processor 318. The processor 318 executes logic stored in the memory 320 to receive the calculated cumulative average trading price from the averaging module 302 through the communications interface 316 and disseminate the calculated average trading price over the communications network 308 to the market participants 322.

The trading module 306 comprises a communications interface 326, a processor 328 coupled with the communications interface 326, and a memory 330 coupled with the processor 328. The processor 328 executes logic stored in the memory 330 to receive bids and offers over the communications network 308 to buy or sell positions in an Asian derivative, as described above, execute the buy and sell orders, and pass the results of the buy or sell order for the Asian derivative to the dissemination module 304 to be disseminated over the communications network 308 to the market participants 322.

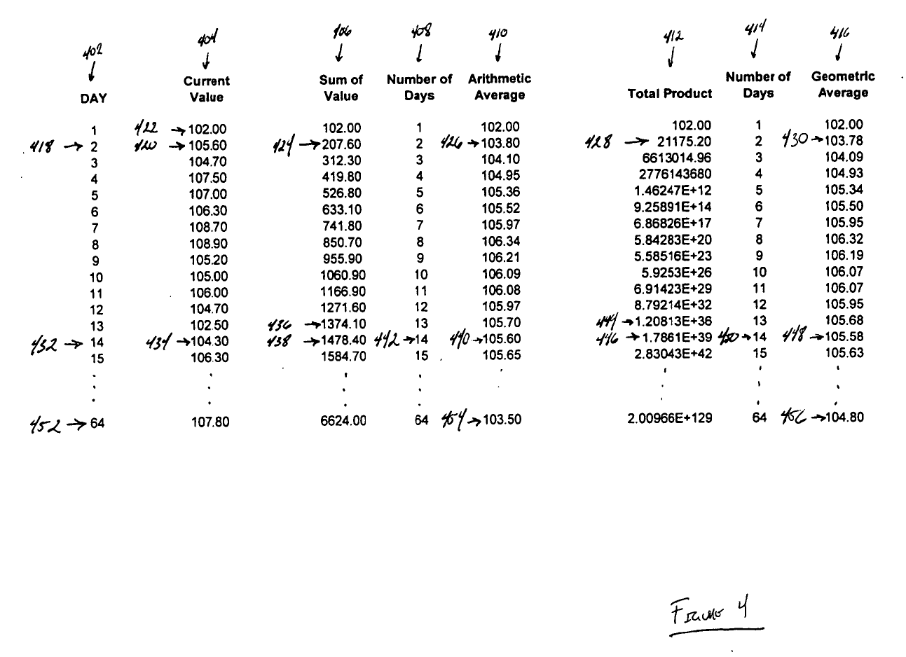

FIG. 4 is a table showing values for an Asian derivative over a 90-day calculation period having 64 trading days. For purposes of illustration, values are only listed for the first 15 trading days and the last trading day of the calculation period. The first column 402 represents the number of days that have passed in the calculation period; column 404 shows the value of the underlying asset at the end of each trading day; column 406 shows the sum of closing prices for the underlying asset up to the current trading day; column 408 shows the number of trading days that have passed in the calculation period; column 410 shows the arithmetic average of the trading price of the underlying asset during the calculation period up to the current trading day; column 412 shows the product of each of the closing prices for the underlying asset up to the current trading day; column 414 shows the number of trading days that have passed in the calculation period; and column 416 shows the geometric average of the trading price of the underlying asset during the calculation period up to the current trading day.

In one example, the Asian derivative is an Asian futures contract having a 90-day calculation period. At the end of the 90-day calculation period, the purchaser of the Asian futures contract agrees to purchase the underlying asset from the seller of the Asian futures contract at the cumulative realized average price of the underlying asset.

On the second day 418 of the calculation period, the underlying asset closes at a trading price of 105.60 (420). To calculate the cumulative arithmetic average on the second day 418 of the calculation period, the closing trading price on the second day 420 is summed with the closing trading price on all previous trading days of the calculation period. On the second trading day 418, the closing trade price of the second trading day 420 is added to the closing price of the first trading day 422 to obtain the sum 424 of the trading prices of the underlying asset up to the current date. The cumulative arithmetic average on the second day 426 may then be calculated according to the formula described above as:

$$Arithmetic Average = \frac{{\sum }_{i = 1}^{N} {TP}_{i}}{N} = \frac{207.6}{2} = 103.80 .$$

To calculate the cumulative geometric average on the second day 418 of the calculation period, the product is taken of the closing price on the second day 420 with the closing trading price on all previous trading days of the calculation period. On the second trading day 418, the product is taken of the closing trading price of the first and second trading day 420, 422 to obtain a total product 428. The cumulative geometric average on the second trading day 430 may then be calculated according to the formula described above as:

$$Geometric Average = \sqrt[N]{{TP}_{1} * {TP}_{2} . * … * {TP}_{N}} = \sqrt[2]{102.00 * 105.60} = 103.78$$

This process is repeated for each trading day of the calculation period. For example on the 14^{th} day 432 of the calculation period, the underlying asset has a closing price of 104.30 (434). To obtain a cumulative arithmetic average 440, the closing price on the 14^{th} day 434 is added to the sum of the closing price of all previous trading days 436 to obtain a current sum of the closing prices 438. The current sum 438 is then divided by the number of trading days 442, resulting in a value of 105.60. To obtain a cumulative geometric average 448, the product is taken of the closing price on the 14^{th} day 434 and the product of all previous trading days 444 to obtain a total product 446. The 14^{th} (450) root is taken of the total product 446, resulting in a value of 105.58.

As seen in FIG. 4, on the last trading day 452, the underlying asset has a cumulative arithmetic average 454 of 103.50 and a cumulative geometric average 456 of 104.80. Therefore, due to the fact the current value of the underlying asset 458 on the last trading day is more than the cumulative arithmetic average 454 and the cumulative geometric average 456, the purchaser of the Asian derivative receives a profit regardless of whether the Asian future contract is based on an arithmetic average or a geometric average. However if at the end of the calculation period the cumulative arithmetic average and the cumulative geometric average is more than the current value of the underlying asset, the purchaser of the Asian futures contract will realize a loss, regardless of whether the Asian futures contract is based on an arithmetic average or a geometric average.

In one embodiment, the Asian futures contract may be structured so that the underlying asset is actually delivered to the purchaser of the Asian futures contract. In another embodiment, the Asian futures contract may be structured so that the cash difference between the cumulative arithmetic or geometric average and the current price of the underlying asset is delivered to the purchaser of the Asian futures contract.

Alternatively, the Asian derivative may be an Asian option contract having a strike price based on the cumulative arithmetic average or the cumulative geometric average. In one example, an Asian call option contract may have a strike price of 106.00 based on the cumulative arithmetic average of the underlying asset and be exercised at any time during the 90-day calculation period. Therefore, a holder of the Asian call option contract could only exercise their option to make a profit during the 90-day calculation period when the cumulative arithmetic average is calculated to be above 106.00 such as on days 8-11. On all other shown trading days of the calculation period, if the holder of the Asian call option exercised their option it would result in a loss.

In another example, an Asian call option contract may have a strike price of 103.00 based on the cumulative arithmetic average of the underlying asset and only be exercised at the end of the 90-day calculation period. Therefore, due to the fact the cumulative arithmetic average is calculated to be above 103.00 at the end of the 90-day calculation period, the holder of the Asian call option may exercise their option for a profit. However, if the cumulative arithmetic average was calculated to be at or below 103.00 at the end of the 90-day calculation period 454, the holder of the Asian call option may not exercise their option for a profit.

In yet another example, an Asian put option contract may have a strike price of 106.00 based on the cumulative arithmetic average and be exercised at any time during the 90-day calculation period. Therefore, a holder of the Asian put option contract could only exercise their option to make a profit during the 90-day calculation period when the cumulative arithmetic average is calculated to be below 106.00 such as on days 1-7, 12-15, and 64. On all other shown trading days of the calculation period, if the holder of the Asian put option exercised their option it would result in a loss.

Similarly, in another example, an Asian put option contract may have a strike price of 103.00 based on the cumulative arithmetic average and only be exercised at the end of the 90-day calculation period. Therefore, due to the fact the cumulative arithmetic average is calculated to be above 103.00 at the end of the 90-day calculation period, the holder of the Asian put option may not exercise their option for a profit. However, if the cumulative arithmetic average was calculated to be below 103.00 at the end of the 90-day calculation period, the holder of the Asian put option can exercise their option for a profit.

It will be appreciated that while the above Asian derivative examples were based on the cumulative arithmetic average of the underlying asset, these same Asian derivatives could be based on the cumulative geometric average of the underlying asset.

According to another aspect of the present invention, chooser options may be created based on Asian options. A chooser option is an option wherein the purchaser of the option buys a call or a put option at some time in the future. The call and the put option will typically share the same expiration date and the same strike price (value), although, split chooser options may be crafted wherein the call and the put options have different expirations and/or different strikes.

Chooser options are advantageous in situations in which investors believe that the price of the underlying asset is for a significant move, but the redirection of the move is in doubt. For example, some event, such as the approval (disapproval) of a new product, a new earnings report, or the like, may be anticipated such that positive news is likely cause the share price to rise, and negative news will cause the share price to fall. The ability to choose whether an option will be a put or a call having knowledge of the outcome of such an event is a distinct advantage to an investor.

The purchase of a chooser option is akin to purchasing both a put and a call option on the same underlying asset. Typically the chooser option is priced accordingly. In the present case, purchasing an Asian chooser option amounts to buying both a put and a call option based on the average price of an underlying asset during a calculation period. Chooser options may be traded on an exchange just like other Asian derivative. The only accommodations necessary for adapting an exchange for trading chooser options is that a final date for making the choice between a call option and a put option must be established and maintained. Also, post trade processing on the exchange's systems must be updated to implement and track the choice of the call or a put once the choice has been made. One option for processing the chosen leg of a chooser option is to convert the chooser option into a standard option contract according to the standard series for the same underlying asset and having the same strike price as the chosen leg of the chooser option.

It is therefore intended that the foregoing detailed description be regarded as illustrative rather than limiting, and that it be understood that it is the following claims, including all equivalents, that are intended to define the spirit and scope of this invention.

1. A method of creating derivatives based on an average trading price of an underlying asset during a calculation period, comprising:
receiving trading price information for the underlying asset from at least one index provider;
calculating on a processor the average trading price of the underlying asset during the calculation period as a function of the trading price information;
displaying Asian derivatives based on the calculated average trading price of the underlying asset on a trading facility display device coupled to a trading platform;
receiving at least one Asian derivative quote from a liquidity provider; and
transmitting at least one Asian derivative quote of at least one liquidity provider from the trading facility to at least one market participant.

2. The method of claim 1, wherein the underlying asset is selected from the group consisting of: equity indexes or securities; fixed income indexes or securities; foreign currency exchange rates; interest rates; commodity indexes; and commodity or structured products traded on a trading facility or over-the-counter market.

3. The method of claim 1, wherein the average trading price is a geometric average of the trading price of the underlying asset during the calculation period.

4. The method of claim 1, wherein the average trading price is an arithmetic average of the trading price of the underlying asset during the calculation period.

5. The method of claim 1, wherein the trading facility is an exchange.

6. The method of claim 1, wherein the liquidity provider is selected from the group consisting of: Designated Primary Market Makers (“DPM”), market makers, locals, specialists, trading privilege holders, and, members.

7. The method of claim 1, wherein the market participant is selected from the group consisting of: a liquidity provider, a brokerage firm, and a normal investor.

8. The method of claim 1, further comprising:
executing trades for the Asian derivatives by matching bids and offers to buy and sell positions in Asian derivatives.

9. The method of claim 1, wherein at least one of the Asian derivatives is an Asian option contract.

10. The method of claim 1, wherein at least one of the Asian derivatives is an Asian futures contract.

11. The method of claim 1, further comprising:
calculating a cumulative realized average price on a processor, wherein the cumulative realized average price is the average trading price of the underlying asset up to a current date;
displaying the cumulative realized average price on the trading facility display device; and
transmitting the cumulative realized average price from the trading facility to at least one market participant.

12. The method of claim 11, wherein the cumulative realized average price is calculated in real time.

13. The method of claim 11, further comprising:
transmitting the cumulative realized average price over at least one dissemination network.

14. The method of claim 1, wherein the trading platform is an open outcry platform.

15. The method of claim 1, wherein the trading platform is an electronic platform.

16. The method of claim 1, wherein the trading platform is a hybrid of an open outcry platform and an electronic platform.

17. A method of creating derivatives based on an average trading price of an underlying asset during a calculation period, comprising:
choosing at least one underlying asset to be a base of an Asian derivative;
receiving trading price information for the at least one underlying asset from at least one index provider;
calculating the average trading price of the at least one underlying asset during the calculation period as a function of the trading price information;
displaying at least one Asian derivative based on the calculated average trading price of the at least one underlying asset on a trading facility display device coupled to a trading platform;
receiving bids and offers to buy and sell positions in the at least one Asian derivative from market participants; and
executing trades for the at least one Asian derivative by matching bids and offers to buy and sell positions in Asian derivatives.

18. The method of claim 17, further comprising:
receiving at least one quote for the at least one Asian derivative from a liquidity provider; and
transmitting at least one quote for the at least one Asian derivative of at least one liquidity provider over a dissemination network to at least one market participant.

19. The method of claim 18, wherein the liquidity provider is selected from the group consisting of: Designated Primary Market Makers (“DPM”), market makers, locals, specialists, trading privilege holders, and members.

20. The method of claim 18, wherein the market participant is selected from the group consisting of: a liquidity provider, a brokerage firm, and a normal investor.

21. The method of claim 18, further comprising:
calculating a cumulative realized average price reflecting the average trading price of the at least one underlying asset up to a current date;
displaying the cumulative realized average price on the trading facility display device; and
transmitting the cumulative realized average price over the dissemination network to at least one market participant.

22. The method of claim 17, wherein the underlying asset is selected from the group consisting of: equity indexes or securities; fixed income indexes or securities; foreign currency exchange rates; interest rates; commodity indexes; and commodity or structured products traded on a trading facility or over-the-counter market.

23. The method of claim 17, wherein the average trading price is a geometric average of the trading price of the at least one underlying asset during the calculation period.

24. The method of claim 17, wherein the average trading price is an arithmetic average of the trading price of the at least one underlying asset during the calculation period.

25. The method of claim 17 wherein the Asian derivative is an Asian futures contract.

26. The method of claim 17 wherein the Asian derivative is an Asian option contract.

27. A system for creating and trading derivatives based on an average price of an underlying asset during a calculation period, comprising:
an average trading price module comprising a first processor, a first memory coupled with the first processor, and a first communications interface coupled with a communications network, the first processor, and the first memory;
a dissemination module coupled with the average trading price module, the dissemination module comprising a second processor, a second memory coupled with the second processor, and a second communications interface coupled with the communications network, the second processor, and the second memory;
a first set of logic, stored in the first memory and executable by the first processor to receive trading prices for an underlying asset of an Asian derivative through the communications network; calculate a cumulative realized average price; and pass the cumulative realized average price to the dissemination module; and
a second set of logic, stored in the second memory and executable by the second processor to receive the cumulative realized average price for the underlying asset from the average trading price module; and disseminate the cumulative realized average price through the second communications interface to at least one market participant.

28. The system of claim 27, further comprising:
a trading module coupled with the dissemination module, the trading module comprising a third processor, a third memory coupled with the third processor, and a third communications interface coupled with the communications network, the third processor, and the third memory; and
a third set of logic, stored in the third memory and executable by the third processor, to receive at least one buy or sell order for the Asian derivative; execute the buy or sell order; and pass a result of the buy or sell order to the dissemination module; and
a fourth set of logic, stored in the second memory and executable by the second processor to receive the result of the buy or sell order from the trading module and disseminate the result of the buy or sell order through the second communications network to the at least one market participant.

29. A system for creating and trading derivatives based on an average trading price of an underlying asset during a calculation period, comprising:
an average trading price module coupled with a communications network for receiving trading prices for an underlying asset of an Asian derivative and calculating a cumulative realized average price for the underlying asset;
a dissemination module coupled with the average trading price module and the communications network for receiving the cumulative realized average price from the average trading price module and disseminating the cumulative realized average price of the underlying asset to at least one market participant; and
a trading module coupled with the dissemination module and the communications network for receiving at least one buy or sell order for the Asian derivative and executing the at least one buy or sell order.
